(19) United States
(12) Patent Application Publication
(10) Pub. No.: US 2007/0102515 A1
(43) Pub. Date: May 10, 2007

(54) Automated coding system and method

(75) Inventors: Steven F. Windham, Montgomery, AL (US); Alexander G. Nowak, Geneva, IL (US); Jeff Nowling, Geneva, IL (US); James C. Hughes, Glenmoore, PA (US)

Correspondence Address: BAKER & DANIELS LLP, 805 15TH STREET, NW, SUITE 700, WASHINGTON, DC, 20005, US

(73) Assignee: Omron Electronics, Inc., Schaumberg, IL (US)

(21) Appl. No.: 11/527,720

(22) Filed: Sep. 27, 2006

Related U.S. Application Data
(60) Provisional application No. 60/720,472, filed on Sep. 27, 2005.

(51) Int. Cl. G06Q 30/00; G06K 15/00

(52) U.S. Cl. 235/385; 235/383

(57) ABSTRACT

The present invention is directed to a method and system for automatic product coding and verification. The system may include a product identification component for identifying a product for coding, a code determination subsystem for automatically determining a product code based on the product identification, and a printing subsystem for printing the determined product code on the product. The system may also include an inspection subsystem for inspecting the printed product code and generating an alarm upon inspection failure. The code determination subsystem may include a controller for receiving the product identification from the product identification component, and a product information database for providing additional product information associated with the identified product to the controller. The code determination subsystem may additionally include a code determination module integrated with the controller for determining a product code based on the additional product information supplied by the product information database.

### PRIORITY DATA

The present application claims priority to U.S. Provisional Patent Application Ser. No. 60/720,472, filed on Sep. 27, 2005.

### TECHNICAL FIELD

Embodiments of the present invention relate to an automatic coding system and in particular a system for automatically selecting and applying an appropriate data and lot code to a product.

### BACKGROUND OF THE INVENTION

Currently, many consumable products are manufactured with freshness dates, lot codes, and plant codes and other pertinent data for traceability reasons. Such coding is often required by the FDA and organizational internal quality standards. High-speed variable data, inkjet, laser, or other permanent marking printers are used to print most of these freshness date codes and other types of codes on products during the manufacturing process.

Manufacturers who package products face several obstacles when it comes to marking and verifying correct date and lot codes. These obstacles include incorrect downloads to printing equipment, unreadable codes, and incomplete codes, particularly on concave can bottoms at high speeds. When any one of these problems arises, it results in expensive product and packaging waste and a loss of productivity.

Typically, it has been the task of operators to enter the expiration date for each product being filled. The expiration dates for these products vary, affected by their contents. For example, products containing sugar have a shelf-life of thirty nine weeks, while products without sugar have lives varying from thirteen to twenty six weeks, depending on other product ingredients. To account for these differences, when a factory line changes from one product to another, operators often use a keypad to manually enter the relevant data, after referring to a printed chart for the correct product shelf-life and calculating the expiration date. The shelf-life for a product may be determined based on complex algorithms that incorporate product ingredients as input. Typically, a key spoilage substance is the major indicator of product shelf-life. The chart that machine operators often consult typically includes a printout resulting from running a computer program incorporating complex algorithms for calculating this information. The chart typically includes the calculated shelf-life and the operator is then required to determine the freshness code based on the calculated shelf-life, the current date, and a specific coding format.

Regardless of the product, misprinting of date codes and other information on consumable products can be a significant problem. For example, in the field of soft-drink bottling, the high-speed processing of bottles and cans may cause errors in the printing process which are difficult to catch and time consuming to correct.

On a line running at sixteen hundred cans per minute, one incorrect date code, whether the result of misreading the chart or of miss-keying the code itself, could incorrectly code a large quantity of cans before being detected, especially since many existing modes of verification have included implementing line workers for pulling a sample can about every fifteen minutes to manually check the codes. Accordingly, when errors in the present coding system occur, significant costs are incurred as the miss-marked products must be identified and the line must be reset.

Thus, the use of spreadsheets on the factory floor has evolved to help an operator to determine what data must be entered into the printer. This procedure has several inherent problems. First, the operator can easily mistype a freshness date. Additionally, the operator can easily misread a spreadsheet and enter the freshness code from the wrong line. Both of these problems result in the production of miscoded products that must be disposed of. Where a process runs at high-speed, thousands of products can be mislabeled in a matter of minutes. In addition, label printers can fail to print anything when a nozzle is blocked or when the printing material, such as ink or ribbon or the like, is depleted.

Accordingly, in order to overcome the difficulties identified above, a system and method are needed for minimizing operator and machine error during product coding.

### BRIEF SUMMARY OF THE INVENTION

In one aspect, a system is provided for automatically affixing a code to a product. The system may include a product identification component for identifying a product for coding and a controller for receiving the product identification from the product identification component. The system may further include a product information database for providing product information associated with the identified product to the controller. The system may also include a code determination module integrated with the controller for determining a product code based on the additional product information supplied by the product information database.

In a further aspect of the invention, a method may be provided for automatically affixing a code to a product. The method may include identifying a product and receiving the product identification at a controller. The controller consults a product information database to obtain product information based on the product identification. The method may additionally include determining a product code using the controller based on the product information obtained from the product information database.

In yet a further aspect of the invention, a system may be provided for automatically affixing a code to a product. The system may include a product identification component for identifying a product for coding and a code determination subsystem for automatically determining a product code based on the product identification. The system may additionally include a printing subsystem for printing the determined product code on the product and an inspection subsystem for inspecting the printed product code and generating an alarm upon inspection failure.

### BRIEF DESCRIPTION OF THE DRAWINGS

The above-mentioned and other features of this invention, and the manner of attaining them, will become more apparent and the invention itself will be better understood by reference to the following description of embodiments of the invention taken in conjunction with the accompanying drawings, wherein:

FIG. 1 is a block diagram illustrating components of an automated date and lot coding system in accordance with an embodiment of the invention;

FIG. 2 is a graphic illustration of a touch screen user interface component in accordance with an embodiment of the invention;

FIG. 3 is schematic illustration of touch screen components in accordance with an embodiment of the invention;

FIGS. 4A-4D illustrate date and lot code misapplications detected in accordance with an embodiment of the invention;

FIG. 5 is a block diagram illustrating a vision system for inspecting applied date and lot codes in accordance with an embodiment of the invention;

FIG. 6 is a flow chart illustrating automatic application of date and lot codes in accordance with an embodiment of the invention; and

FIG. 7 is a flow chart illustrating a process for inspecting the automatically applied date and lot codes in accordance with an embodiment of the invention.

### DETAILED DESCRIPTION OF PREFERRED EMBODIMENTS

Embodiments of the present invention are directed to an automated product coding system and method and in particular to an automated date and lot coding system and method.

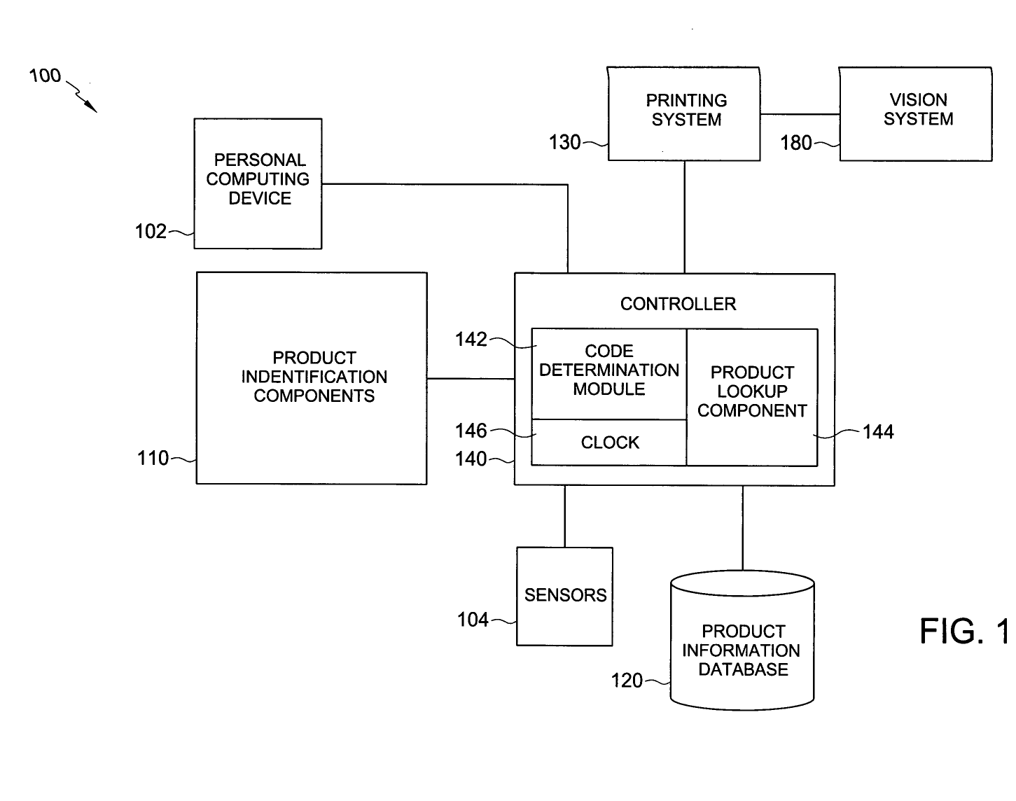

FIG. 1 is a block diagram illustrating components of an automated date and lot coding system 100 in accordance with an embodiment of the invention. The system 100 may include a personal computing device 102, product identification components 110, sensors 104, and a product information database 120 connected with a controller 140. A printing system 130 and a vision system 180 may also be connected with the date and lot coding system.

As illustrated, the controller 140 may include multiple components such as a code determination module 142, a clock 146, and a product lookup component 144. As will be further described below, these components of the controller 140 interact with the product identification components 110 and the product information database 120 to automatically determine a product code such as a date code for forwarding to the printing system 130. The vision system 180 may check the printed codes for correctness after application to the product by the printing system 130.

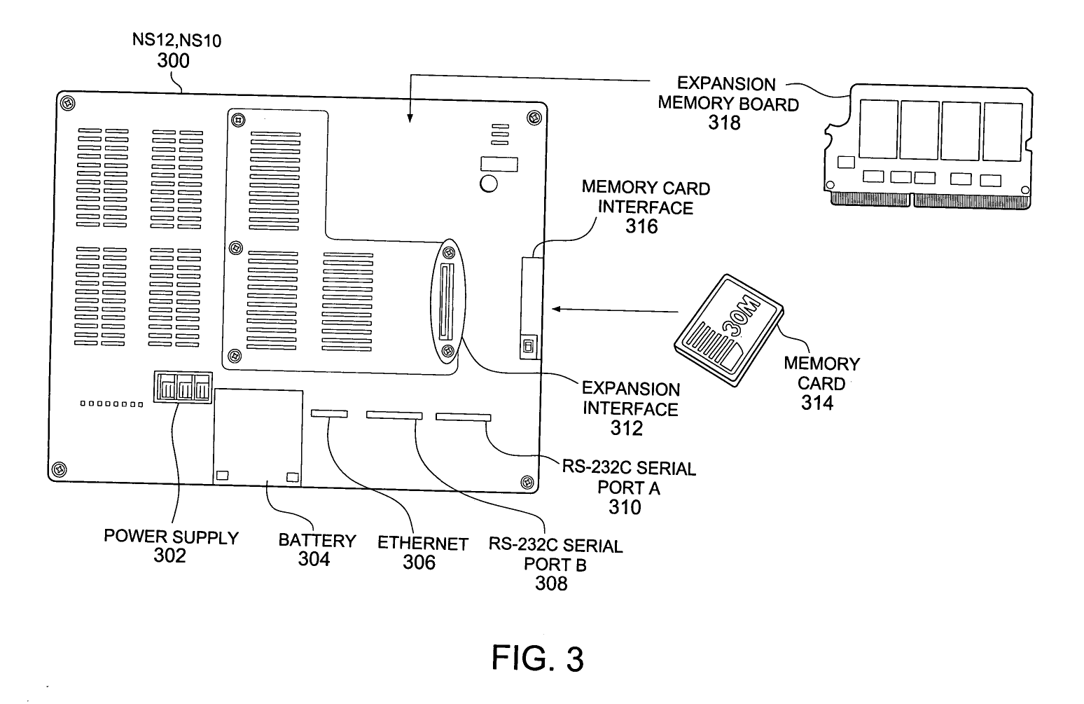

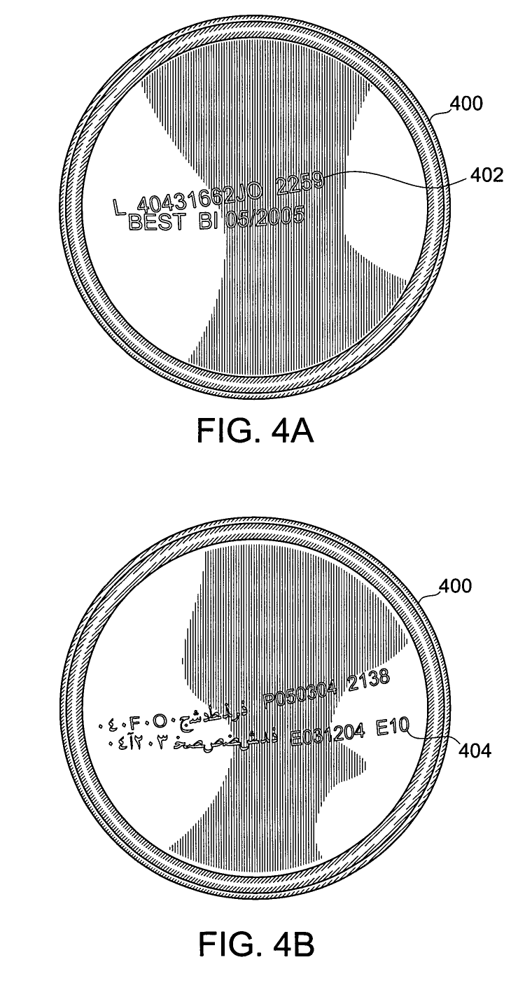

The product identification components 110 may include various mechanisms for identifying a product. In embodiments of the invention, the product identification components 110 include a human machine interface (HMI) for providing an interface between the controller 140 and the system operator. The HMI may include a touch screen for allowing an operator to select a product choice for coding. The touch screen may provide the machine operator with a list of products. From this list, an operator may designate the product being manufactured and enter this information into the system by touching the appropriate space on the screen. This embodiment is further described below with reference to FIGS. 3 and 4.

Alternatively to the HMI touch screen, the product identification components 110 may be equipped with an optical or RFID reader which may be used to identify the product. Optionally, sensors 104 may operate in conjunction with the product identification components 110 to identify a product based on any distinguishing product characteristics that may be sensed by the sensors 104. Furthermore, product identification components 110 may implement both operator and machine checks to ensure that a correct product identification is made. For example, an operator may enter a product and an automated electronic identification will be conducted and will be required to match the operator input. With this product identification information, the illustrated components of the controller 140 may calculate the freshness date based on information found in the product information database 120 and the product's specific algorithm and further access the lot code or any other codes to be determined by the system. The calculated freshness date and other codes may then be automatically sent to the printing system 130.

The controller 140 preferably comprises a Programmable Logic Controller (PLC). The PLC may include one or more CPUs for processing programmable components contained in a memory card or extendable memory. The PLC may further include a power supply unit, I/O control module, I/O connecting cables, programming console, programming software, and other components. Preferably, the PLC is a small sized module that provides high speed communication, such as Omron's CJ1. The Omron CJ1 programmable logic controller (PLC) may hold the date and lot code program components and controlling coding and verification. Multiple CJ1 PLCs may be connected module to module using simple locking connectors.

Preferably, the controller or PLC 140 has been programmed with a series of program modules or components having a series of algorithms for calculating product codes. For simplification, FIG. 1 shows these program components without illustrating each feature of the controller 140. However, these program components may be stored in memory and executed by a CPU within the controller 140. As illustrated, the controller 140 may include a code determination module 142, a clock 146, and a product lookup component 144 for consulting the product information database 120. Although the product information database 120 is shown as a separate component, it may optionally be fully integrated with the controller 140.

In embodiments of the invention, the code determination module 142 calculates a freshness date code for the product based upon the current date as set by the clock 146 and the shelf-life of the product as set forth in the product information database 120. For other codes, such as the lot code, the code may also be calculated by the code determination module 142 in accordance with an appropriate formula or the code itself may be contained within the product information database 120.

The product information database 120 may be or include a collection of records including at least one record for each product, stored in a systematic manner so that a computing module such as the product lookup component 144 can consult the product information database 120. Each record may include a set of data elements useful in making code determination decisions. For example, the product information database 120 may include a record for a soft drink such as cola. The record may include data elements such as a shelf-life, bar code information that identifies a product lot, or RFID information.

By either calculating the freshness date and/or other codes based on each of the product selections through an HMI or through automatic recognition by the system, the opportunity for human error may be substantially eliminated for typographical errors and calculation errors.

According to a preferred embodiment of the present invention, the printing system 130 for printing codes on the products may include filling line printers that are preferably comprised of twin Videojet Model 273i dual head ink jet printers.

The personal computing device 102 may optionally be included in the system in order to provide additional system control, supervision, and programming capabilities. If the personal computing device 102 is included, it may comprise one or multiple distributed computing devices. The personal computing device would typically include a processing unit, a memory, a peripheral interface, a removable memory interface, a network interface, and a user input interface. A system bus may be used to couple the aforementioned components.

The personal computing system memory may include computer storage media in the form of volatile and/or nonvolatile memory such as read only memory (ROM) and random access memory (RAM) A basic input/output system (BIOS), containing the basic routines that help to transfer information between elements, such as during start-up, is typically stored in ROM. RAM typically contains data and/or program modules that are immediately accessible to and/or presently being operated on by processing unit.

The RAM may include an operating system and program data. Application programs stored in RAM may be described in the general context of computer-executable instructions, such as program modules, being executed by a computer. Generally, program modules include routines, programs, objects, components, data structures, etc. that perform particular tasks or implement particular abstract data types.

The personal computing system may also include other removable/non-removable, and volatile/nonvolatile computer storage media. A hard disk drive may be provided that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

A user may enter commands and information through the user input interface using input devices such as a keyboard and pointing device, commonly referred to as a mouse, trackball or touch pad. Other input devices may include a microphone, satellite dish, scanner, or the like. These and other input devices are often connected to the processing unit through the user input interface that is coupled to the system bus, but may be connected by other interface and bus structures, such as a parallel port or a universal serial bus (USB). A monitor or other type of display device and other peripherals may also be connected to the system bus via an interface, such as the peripheral interface.

The personal computing system in embodiments of the present invention may operate in a networked environment using logical connections to communicate with networked components. Logical connections for networking may include a local area network (LAN) or a wide area network (WAN), but may also include other networks. Other components shown in FIG. 1 may operate in a similar computerized environment.

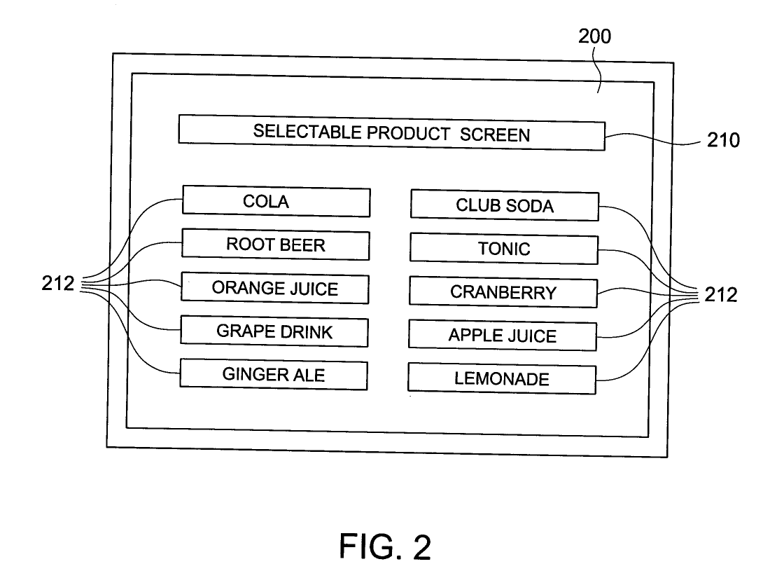

FIG. 2 is a graphic illustration of a touch screen user interface component in accordance with an embodiment of the invention. In embodiments of the invention, it is preferable that operators access the system through an Omron NS12 touch-screen HMI. Operators may preferably use a main screen to log onto the system. A touch screen 200 as shown in FIG. 2, may be included to display a product selection screen 210 and to specify the product selection, selectable from items 212 at the beginning of production In the displayed embodiment, the selectable products are beverages that may be stored in tin cans. Other screens that can be accessed preferably may include such displays as inspection parameters operating data and other information for each lane of products being processed, (i.e. lanes A and B for two split lanes at the printers), each lot code, the number of units inspected, the number of bad reads and the number of alarms issued.

FIG. 3 is schematic illustration of touch screen components for an NS12 Omron touch screen 300 in accordance with an embodiment of the invention. A power supply 302 may for example be a 24 Vdc power supply. A battery 304 may be provided. The touch screen 300 may also include connections for Ethernet 306 and serial ports 310 and 312. Interfaces may include an expansion interface 312 and a memory card interface 316 for accommodating a memory card 314. Space may also be provided for an expansion memory board 318.

In addition to errors in determining appropriate codes, printing errors of the selected codes may also occur. FIGS. 4A-4D illustrate date and lot code misapplications that may be detected by the vision system 180 in accordance with an embodiment of the invention. In each of FIGS. 4A-4D, code misapplications are displayed on an aluminum can 400. In FIG. 4A, the aluminum can 400 has a code 402 applied. Although the print of the code 402 is clear, the positioning of the code is poor. In order to correct this type of error, control of the can may be improved or a conveyor section may be replaced. FIG. 4B illustrates the aluminum can 400 with coding 404 that shows poor position control and mixed fonts. To correct this misapplication, the quality of printing should be improved to ensure consistency. Furthermore, a character verification system must be used that reads different character sets. FIG. 4C illustrates the aluminum can 400 having inconsistencies in character spacing and print angles with coding 406. Spacing separation 408 is inconsistent and angle A at 410 differs from angle B at 412. Even though the print 406 appears to be good quality, it is difficult to read if multiple print angles are present. FIG. 4D illustrates the aluminum can 400 having coding 420 with close spacing between lines and characters. The separation may be improved by adding more light to erode darker pixels, thereby making them smaller and adding separation.

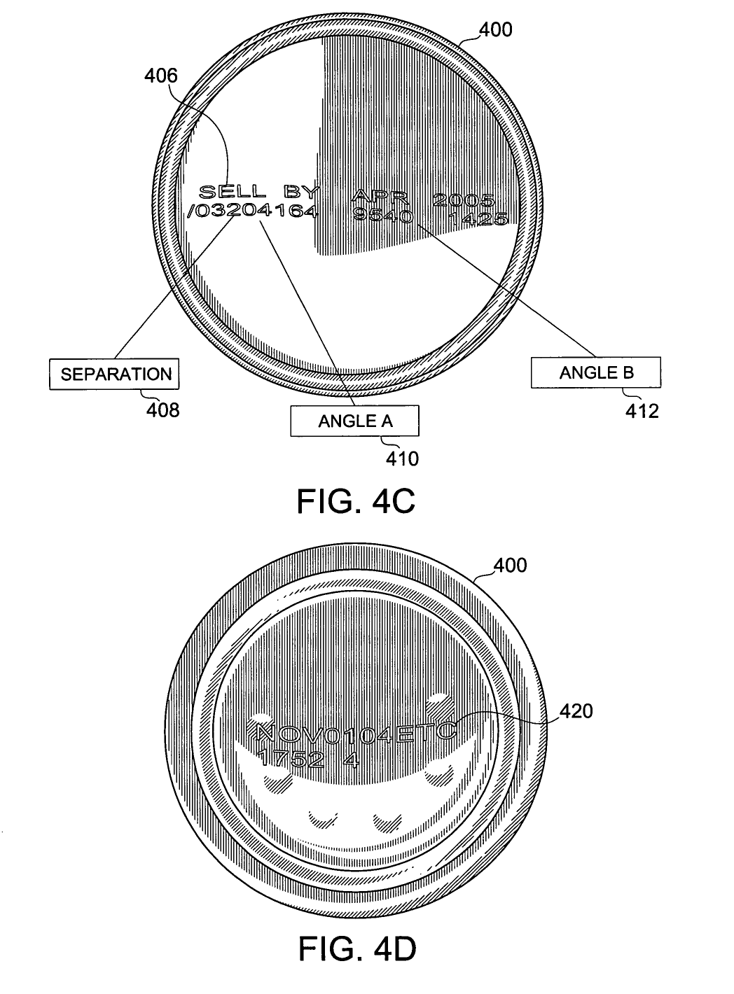

FIG. 5 is a block diagram illustrating a vision system 500 for inspecting applied date and lot codes in accordance with an embodiment of the invention. As discussed in detail below, embodiments of the present invention include a vision system which inspects for the presence, legibility, and correctness of codes, which may include a date code and plant code on a manufactured product. A controller 510 may be connected with cameras 520, a personal computer 530, a monitor 540, and a console 550. The cameras 520 may include high-speed cameras immediately downstream of the printing system 130. The cameras 520 are able to inspect each can for the presence of a code, its legibility and its correctness. A variation from any of the three conditions on any product may be programmed to trigger an alarm light that alerts operators, who can then evaluate the situation and take action to identify the source of the condition and make adjustments or, in extreme cases, shut down the line. The controller 510 may include program components for verification of the presence, legibility, and correctness of the requested codes.

In one preferred embodiment of the invention, the vision system is an Omron F270 vision system. The cameras 520 may include two Omron F160-S2 cameras placed over each of two split production lanes.

Preferably, the vision system controller 510 utilizes two CPUs, two ASIC's and two asynchronous triggers. Preferably, the CPU's for this application run independently of one another and the ASIC's allow for 360 degrees rotational search of the expiration dates and other codes in approximately eight milliseconds. Preferably, the vision system can operate as many as four high-speed cameras able to capture images in 8-16 ms, making it capable of inspecting up to 5,000 parts per minute, so it is easily capable of checking at least 800 products per minute being coded, and thus offering the possibility of expandability.

As an additional enhancement, the vision system 500 of the automatic coding system may be automatically updated with the new freshness data and may automatically check for the new date without operator intervention.

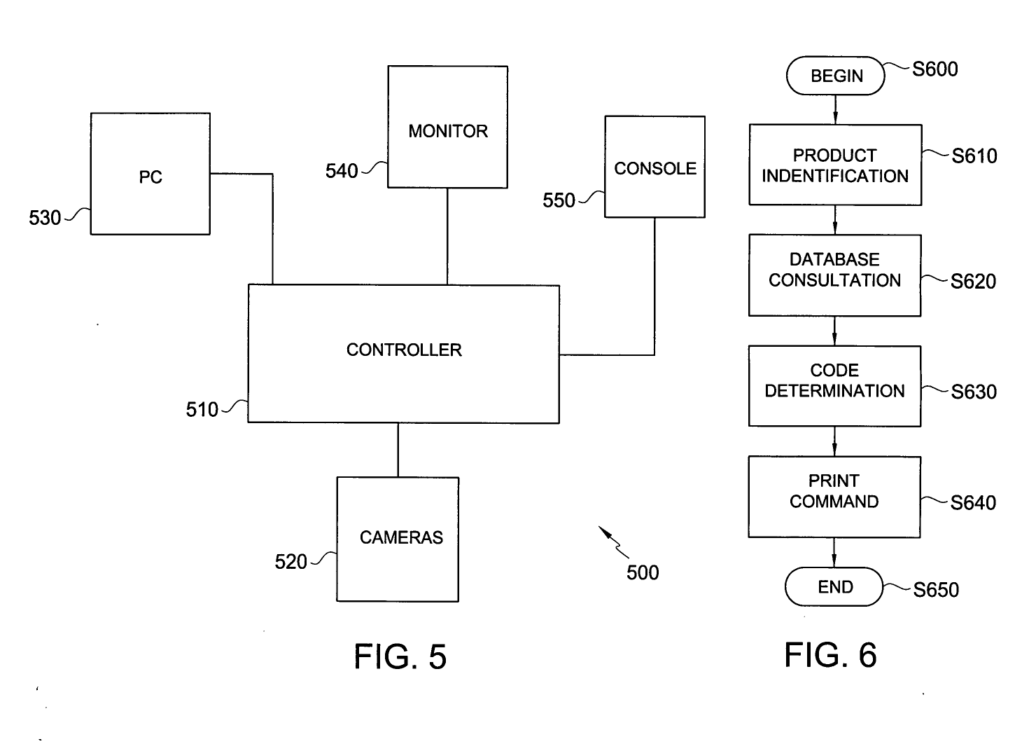

FIG. 6 is a flow chart illustrating automatic application of date and lot codes in accordance with an embodiment of the invention. The process begins in S600 as products are passed down the production line. In S610, product identification occurs. As set forth above, product identification may include minimal operator input, or in some instances may eliminate operator input entirely. For minimal operator input, the operator may select a product from the touch screen and the system will automatically determine the correct codes for the product selected. To eliminate operator input, a bar code reader may read a bar code on the product and the system may automatically determine product codes based on the bar code identification. In order to proceed with automatic code determination, the system consults the product information database in S620. For some types of codes and products, the product information database may provide all essential data. However, in most instances, in S630, the code determination module determines the appropriate codes for application based on the data in the product information database. As set forth above, the code determination module, may determine a date code, based on a shelf-life found in the product information database and a current time and date provided by the controller clock. In S640, the controller sends a print command to the print system in order to print the determined codes.

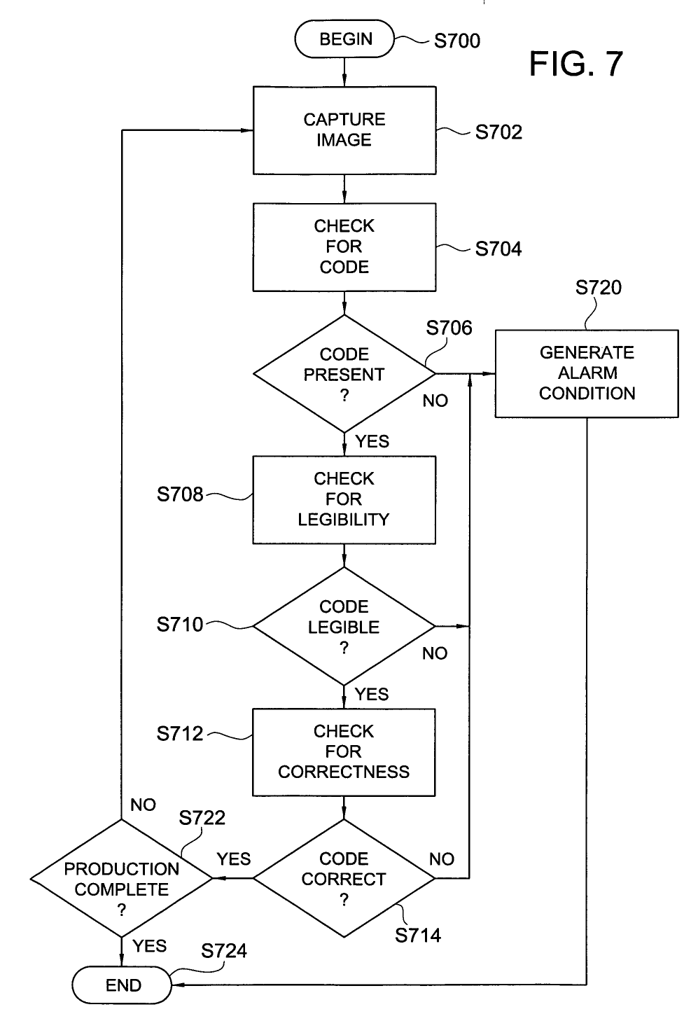

FIG. 7 is a flow chart illustrating a process for inspecting the automatically applied date and lot codes in accordance with an embodiment of the invention. The process begins in S700 after the codes have been applied to the products. In S702, the cameras may capture a product image including the codes. In S704, the vision system checks for the presence of a code or codes. In S706, if no code is present, the vision system generates an alarm condition in S720. If the code is present in S706, the system checks for code legibility in S708. If the code is illegible in S710, the system generates an alarm condition in S720. If the code is legible in S710, the vision system checks for correctness in S712. If the code is incorrect in S714, the vision system generates an alarm condition in S720. If the code is correct in S714, the system determines if production is complete in S722. The process continues until production is complete and ends in S724. The alarm condition 720 may be supplied to the printing system, so that the printing system can automatically determine when quality standards have not been met.

Fully automating the date and lot code input and verifying the results with the machine vision inspection described with respect to FIG. 7 can also provide feedback to the printing system that codes have been printed correctly and in accordance with quality standards.

As set forth above, to solve current limitations and to provide additional advantages, the system of the presentation invention calculates expiration dates automatically from a system database and provides verification and control to the printing process. The preferred system database contains all of the monitored products and their relevant shelf lives as well as other relevant product information for determining product codes. The preferred system further includes a clock which is synchronized with the system's functions and calculations. Within this system, where an operator selects a specific product, or where a specific product is detected, the system of the present invention works to calculate the correct expiration date. This date information, along with lot information is preferably generated automatically by the system. Thereafter, this information is preferably sent directly to the system's printers which print the correct expiration information and other necessary codes on the desired product. In embodiments of the invention, the automated coding system further checks the printed codes to verify their presence, legibility, and correctness.

While particular embodiments of the invention have been illustrated and described in detail herein, it should be understood that various changes and modifications might be made to the invention without departing from the scope and intent of the invention.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

What is claimed is:

1. A system for automatically affixing a code to a product, the system comprising:
a product identification component for identifying a product for coding;
a controller for receiving the product identification from the product identification component;
a product information database for providing additional product information associated with the identified product to the controller; and
a code determination module integrated with the controller for determining a product code based on the additional product information supplied by the product information database.

2. The system of claim 1, wherein the product identification component comprises a touch screen displaying selectable products available for operator selection.

3. The system of claim 1, wherein the product identification component comprises a bar code reader.

4. The system of claim 1, wherein the product identification component comprises an operator entry component and an automatic electronic identification component.

5. The system of claim 1, wherein the controller comprises a product lookup component for looking up product information and the code determination component determines a product code based on the product information.

6. The system of claim 5, wherein the product information comprises a shelf-life and the code determination component access an internal clock to calculate a freshness date based on clock time and shelf-life.

7. The system of claim 1, wherein the product information database associates each product with a shelf-life.

8. The system of claim 1, further comprising a printing system for printing the determined code on the products.

9. The system of claim 8, further comprising a verification system for verifying correct code application.

10. The system of claim 9, wherein the verification system comprises at least one camera and a controller connected with the camera.

11. A method for automatically affixing a code to a product, the method comprising:
identifying a product;
receiving the product identification at a controller, wherein the controller consults a product information database to obtain product information based on the product identification; and
determining a product code using the controller based on the product information obtained from the product information database.

12. The method of claim 11, further comprising requiring an operator to identify a product and enter the identification through a user interface.

13. The method of claim 12, further comprising entering the product by selecting an option on a touch screen.

14. The method of claim 11, further comprising identifying the product by automatically reading a bar code.

15. The method of claim 11, further comprising identifying a product using both an operator entry component and an automatic electronic identification component and requiring matching identifications.

16. The method of claim 11, further comprising implementing a product lookup component within the controller to locate product information in the product information database.

17. The method of claim 16, wherein the product information comprises a shelf-life.

18. The method of claim 17, further comprising accessing an internal controller clock to calculate a freshness date based on clock time and shelf-life.

19. The method of claim 11, further comprising associating each product with a shelf-life in the product information database.

20. The method of claim 11, further comprising printing the determined product code on the products.

21. The method of claim 20, further comprising verifying correct code application with a code verification system.

22. The method of claim 21, further comprising implementing at least one camera connected with a controller in the code verification system.

23. A system for automatically affixing a code to a product, the system comprising:
a product identification component for identifying a product for coding;
a code determination subsystem for automatically determining a product code based on the product identification;
a printing subsystem for printing the determined product code on the product; and
an inspection subsystem for inspecting the printed product code and generating an alarm upon inspection failure.

24. The system of claim 23, wherein the product identification component comprises a touch screen displaying selectable products available for operator selection.

25. The system of claim 23, wherein the product identification component comprises a bar code reader.

26. The system of claim 23, wherein the product identification component comprises an operator entry component and an automatic electronic identification component.

27. The system of claim 23, wherein the code determination subsystem comprises a controller having a product lookup component for looking up product information and the code determination subsystem determines a product code based on the product information.

28. The system of claim 27, wherein the product information comprises a shelf-life and the code determination subsystem accesses an internal controller clock to calculate a freshness date based on clock time and shelf-life.

29. The system of claim 23, wherein the code determination subsystem includes a product information database for associating each product with a shelf-life.

30. The system of claim 29, wherein the verification subsystem comprises at least one camera and a controller connected with the camera.
